(19) United States
(12) Patent Application Publication
(10) Pub. No.: US 2026/0191234 A1
(43) Pub. Date: Jul. 9, 2026

(54) COMPOSITIONS AND METHODS FOR EFFERVESCENT SYSTEMS WITH IMPROVED STABILITY

(71) Applicant: Herbalife International of America, Inc., Los Angeles, CA (US)

(72) Inventors: Pou-Hsiung WANG, Monterey Park (CA); Michael T. YATCILLA, Los Angeles, CA (US)

(21) Appl. No.: 19/551,274

(22) Filed: Feb. 26, 2026

Related U.S. Application Data
(63) Continuation of application No. PCT/US2025/027797, filed on May 5, 2025.
(60) Provisional application No. 63/643,861, filed on May 7, 2024.

(51) Int. Cl. A23L 2/40; A23L 2/39; A23L 2/68; A23P 20/10

(52) U.S. Cl. CPC A23L 2/40; A23L 2/39; A23L 2/68; A23P 20/10

(57) ABSTRACT

Disclosed herein is a citric acid particle having citric acid coated with an organic acid. Further disclosed is a method of producing a coated citric acid particle coated with organic acid, which may include exposing a citric acid particle to a fluid bed to form a fluidized citric acid particle, spraying the fluidized citric acid particle with a coating solution comprising tartaric acid and water to form a coated citric acid particle followed by drying with hot air, and removing the coated citric acid particle from the fluid bed. Additionally, disclosed are a sodium bicarbonate particle having sodium bicarbonate coated with a carbonate salt, a method of producing a coated sodium bicarbonate particle coated with carbonate salt, and a shelf-stable effervescent powdered beverage composition.

### FIELD

The present disclosure relates to coated citric acid particles coated with tartaric acid. The present disclosure also relates to coated sodium bicarbonate particles coated with sodium carbonate. The present disclosure further relates to effervescent powdered beverage compositions with improved stability. The present disclosure also relates to methods of producing coated citric acid particles coated with tartaric acid. The present disclosure also relates to methods of producing coated sodium bicarbonate particles coated with sodium carbonate. More particularly, the present disclosure relates to compositions and methods of producing effervescent powdered beverage systems with improved stability and moisture sensitivity such as can be provided in multiple-serving packages. Additionally, the present disclosure relates to compositions and methods of producing effervescent powdered beverage systems with improved stability and moisture sensitivity such as can be manufactured in ambient temperature and without restrictive humidity-controlled environment.

### BACKGROUND

Food-grade ingredients, including food-grade acids, are often provided as solid particles. These ingredients may be encapsulated by one or more encapsulating ingredients. The encapsulation may be performed for various reasons. Encapsulation may protect the ingredient from moisture, oxygen, heat, or other extreme conditions, thus preventing degradation of the ingredient and increasing the overall shelf life of the product. The encapsulation may provide a sweetening or flavor function to improve or modulate the taste or texture profile of the ingredient. Encapsulation is also sometimes used to provide a controlled-release function upon the occurrence of some discrete event, such as placement of the particle in the mouth or into a liquid beverage, such as water.

Different encapsulated ingredients for food-grade particles have been described. Perhaps the most common encapsulating compositions contain fatty or oily ingredients. These hydrophobic ingredients provide an effective barrier against the environment, especially against ambient moisture, and are thus commonly used to protect hygroscopic ingredients. Other well-known encapsulation materials include cellulose-containing compounds, gums, waxes, carbohydrates, proteins, and polymers, including polyvinylpyrrolidone (PVP).

A known disadvantage of many of these encapsulating ingredients, especially hydrophobic ingredients, is their low solubility and kinetics in water. This hinders the ability of the encapsulated active ingredient to dissolve in water as well, particularly where such dissolving is an important feature of the product, such as in effervescent beverage products. For example, in effervescent systems, common coating excipients such as maltodextrin, hydroxypropyl methylcellulose (HPMC) and polyvinylpyrrolidone (PVP) weaken the reaction of the encapsulated ingredient with water.

Moreover, several commonly used coating agents affect the taste, texture, or appearance of the nutritional product containing the active ingredient.

There is a need in the art for providing encapsulation, including coating, of active ingredients, where the encapsulation effectively protects the active ingredient from moisture and heat, provides good solubility in aqueous solution, while also providing a pleasing taste and texture profile that augments or does not interfere with the qualities of the encapsulated active ingredient.

Effervescent systems are solid systems that, upon mixing with water or other liquid, are capable of releasing carbon dioxide (CO₂). The CO₂ bubbles through the liquid to provide a refreshing taste and sensation, and may also aid in the digestion of other ingredients. Typically, an effervescent system is provided as a stable tablet or powder where the acid and base components are packaged together in a dry state, and must remain inert until the system is placed into an aqueous environment, at which point the acid and base each dissolve and react together to initiate the effervescent reaction.

One disadvantage of current effervescent systems is their susceptibility to ambient moisture and heat in the environment. Even trace amounts of moisture as normally found in air, can degrade the effervescent system, whereby triggering the effervescent reaction before it is ready to be placed in a liquid and consumed. Therefore, effervescent systems, for example, Alka-Seltzer, are often compressed into tablets which are packaged in moisture-proof single serving packaging, such as aluminum foil sachets, or in multipacks with desiccants. In addition, effervescent systems in powder forms may be packaged in moisture-proof single serving packaging such as, aluminum foil packets, to protect the systems from exposing to environmental moisture. Moreover, effervescent products need to be produced under restrictive temperature and humidity control environment with no more than 25% relative humidity and 25° C.

Therefore, there exists a need for improved effervescent systems that are stable under ambient moisture and temperature conditions, and that can be provided in multiple servings containers in powder form. The present application provides improved compositions and methods to solve many of the disadvantages of current systems.

Traditionally, the physical mixing of food-grade organic acids, such as citric acid, tartaric acid, and carbonate base, such as sodium bicarbonate, potassium bicarbonate has been used to attempt reducing the moisture sensitivity of an effervescent system. However, the use of such methods still requires restrictive temperature and humidity controls and single-serving packaging made of the materials such as aluminum foil that can effectively prevent oxygen and moisture penetration.

One known method for encapsulating food-grade particles is an extrusion process. In extrusion processes, the yielded particles often contain the active ingredient surrounded by a matrix-forming agent and other additional ingredients or agents. Extrusion processes also often do not result in a uniform coating, such that the active ingredient is not completely protected from the external environment.

To overcome some of these difficulties associated with methods of pure physical mixing and/or extrusion, alternative methods of reducing moisture sensitivity in effervescent systems have been used. CN 110292566 discloses a method for reducing the viscous impact, or stickiness of effervescent granules, by preparing acid source granules using a wet method, coating PVP on the surface of the acid, then mixing the coated granules with alkali source granules, followed by tableting the ingredients together. JP 2005/132965 provides a method wherein an organic acid powder and a baking soda powder are sprayed onto the surface of a core material while also spraying an aqueous binding solution consisting essentially of an aqueous sugar solution. The method produces foamed granules having a layer containing acid powder and sodium bicarbonate powder. U.S. Pat. No. 6,284,271 provides an effervescent pharmaceutical preparation with a floating generating system comprising at least two coating layers, one of which is a gas generating layer and the other layer is a barrier layers which encloses the generated gas.

However, there remains a need in the art to provide methods for producing a coated citric acid and coated sodium bicarbonate particles that improve moisture sensitivity, are appropriate for multiple-use packaging, and that avoid complex and expensive processing steps. The methods discussed herein solve many of these disadvantages.

### SUMMARY

In a first aspect, a coated citric acid particle is provided. In some embodiments, the coated citric acid particle includes citric acid coated with an organic acid. In some embodiments, the organic acid is tartaric acid. In some embodiments, the tartaric acid can be either L or D form, or the combinations thereof. In some embodiments, sodium form of the acids is not used for effervescent reactions. In some embodiments, a particle size of the coated citric acid particle is between about 10 μm and about 1000 μm. In some embodiments, a weight of the tartaric acid is between about 5 weight-% and about 50 weight-% relative to a total weight of the citric acid. In some embodiments, a thickness of the tartaric acid is less than a thickness of the citric acid. In some embodiments, the coated citric acid particle is a core-shell particle.

In a second aspect, an effervescent powdered beverage composition is provided. The effervescent powdered beverage composition may include, for example, a coated citric acid particle including citric acid coated with tartaric acid, and a decarboxylated sodium bicarbonate particle comprising sodium bicarbonate and sodium carbonate.

In some embodiments, the sodium carbonate is present on a surface of the decarboxylated sodium bicarbonate particle. In some embodiments, a ratio of coated citric acid particles and decarboxylated sodium bicarbonate particles is between about 20%:80% and about 80%:20%.

In a third aspect, an effervescent powdered beverage composition is provided. The effervescent powdered beverage composition may include, for example, a coated citric acid particle including citric acid coated with tartaric acid, and a coated sodium bicarbonate particle including sodium bicarbonate coated with sodium carbonate.

A coated sodium bicarbonate particle is provided. In some embodiments, the coated sodium bicarbonate particle includes sodium bicarbonate coated with a carbonate salt. In some embodiments, the carbonate salt is sodium carbonate. In some embodiments, the carbonate salt is potassium carbonate. In some embodiments, a particle size of the coated sodium bicarbonate particle is between about 10 μm and about 1000 μm. In some embodiments, a weight of the sodium carbonate is between about 5 weight-% and about 50 weight-% relative to a total weight of the sodium bicarbonate. In some embodiments, a thickness of the sodium carbonate is less than a thickness of the sodium bicarbonate. In some embodiments, the coated sodium bicarbonate particle is a core-shell particle.

In some embodiments, the effervescent powdered beverage composition may include one or more ingredients selected from the group including sweeteners, preservatives, fillers, food colorants, vitamins, minerals, amino acids, botanicals, active pharmaceutical ingredients (API), natural flavors, artificial flavors, antifoaming agents, and combinations thereof.

In some embodiments, the effervescent powdered beverage composition may include one or more ingredients selected from the group consisting of microcrystalline cellulose, corn syrup solids, natural fruit flavor, ascorbic acid, sucralose, niacinamide, maltodextrin, riboflavin, biotin, and combinations thereof. In some embodiments, the effervescent powdered beverage composition may include active pharmaceutical ingredients (API). In some embodiments, the API may be selected from the group consisting of analgesics, antacids, electrolytes, antihistamines, and combinations thereof.

In some embodiments, the effervescent powdered beverage composition is packaged in a multiple serving container. In some embodiments, the multiple serving container includes a desiccant. In some embodiments, the desiccant includes silica. In some embodiments, a ratio of coated citric acid particles and coated sodium bicarbonate particles is between about 20%:80% and about 80%:20%. In some embodiments, the ratio of coated citric acid particles is higher than sodium bicarbonate particles.

In a fourth aspect, a method for producing a coated citric acid particle is provided. In some embodiments, the method may include, for example, (i) exposing a citric acid particle to a fluid bed to form a fluidized citric acid particle, (ii) spraying the fluidized citric acid particle with a coating solution including tartaric acid and water to form a coated citric acid particle followed by drying with hot air, and (iii) removing the coated citric acid particle from the fluid bed. In some embodiments, steps (i) to (ii) are ongoing until a desired coating level is achieved. In some embodiments, a temperature of the inlet air is between about 25° C. and about 95° C. In some embodiments, a velocity of the processing air flow is at least about 50 cfm. In some embodiments, a velocity of the processing air flow is at least about 900 cfm. In some embodiments, a velocity of the processing air flow is at least about 4000 cfm. In some embodiments, a velocity of the processing air flow is between about 50 cfm and about 4000 cfm.

In some embodiments, step (ii) includes a spray rate of at least about 5 g/min. In some embodiments, step (ii) includes a spray rate of at least about 75 g/min. In some embodiments, step (ii) includes a spray rate of at least about 2000 g/min. In some embodiments, step (ii) includes a spray rate of between about 5 g/min and about 2000 g/min. In some embodiments, step (ii) comprises a spray atomization pressure of between about 1 bar and about 15 bar. In some embodiments, step (ii) comprises an inlet air temperature of between about 25° C. and about 95° C. In some embodiments, step (ii) comprises top-spraying. In some embodiments, step (ii) comprises bottom-spraying or tangential-spraying.

In some embodiments, a coating solution further comprises a binder. In some embodiments, the binder is selected from the group consisting of maltodextrin, lipid, polymer, and combinations thereof. In other embodiments, a binder may not be used. In some embodiments, the method for producing a coated citric acid particle includes cooling the coated citric acid particle to an ambient air temperature.

In a fifth aspect, a method of producing a coated sodium bicarbonate particle is provided. In some embodiments, the method includes, for example, the following steps: (i) exposing a sodium bicarbonate particle to a fluid bed to form a fluidized sodium bicarbonate particle, (ii) spraying the fluidized sodium bicarbonate particle with a coating solution having sodium carbonate and water to form a coated sodium bicarbonate particle followed by drying with hot air, and (iii) removing the coated sodium bicarbonate particle from the fluid bed. In some embodiments, steps (i) to (ii) are ongoing until a desired coating level is achieved. In some embodiments, a temperature of the inlet air is between about 25° C. and about 95° C. In some embodiments, a velocity of the processing air flow is at least about 50 cfm. In some embodiments, a velocity of the processing air flow is at least about 900 cfm. In some embodiments, a velocity of the processing air flow is at least about 4000 cfm. In some embodiments, a velocity of the processing air flow is between about 50 cfm and about 4000 cfm.

In some embodiments, step (ii) includes a spray rate of at least about 5 g/min. In some embodiments, step (ii) includes a spray rate of at least about 75 g/min. In some embodiments, step (ii) includes a spray rate of at least about 2000 g/min. In some embodiments, step (ii) comprises a spray rate of between about 5 g/min and about 2000 g/min. In some embodiments, step (ii) comprises a spray atomization pressure of between about 1 bar and about 15 bar. In some embodiments, step (ii) comprises an inlet-air temperature of between about 25° C. and about 95° C. In some embodiments, step (ii) comprises top-spraying. In some embodiments, step (ii) comprises bottom-spraying or tangential-spraying.

In some embodiments, the coating solution further comprises a binder. In some embodiments, the binder is selected from the group consisting of maltodextrin, lipid, polymer, and combinations thereof. In other embodiments, a binder may not be used. In some embodiments, the method of producing a coated sodium bicarbonate particle includes cooling the coated sodium bicarbonate particle to an ambient air temperature.

In another aspect a coated citric acid particle including citric acid coated with tartaric acid is disclosed. The tartaric acid can be either L or D form, or the combinations thereof. The coated citric acid particle, wherein a particle size of the coated citric acid particle is between about 10 μm and about 1000 μm. In some embodiments, of a coated citric acid particle a weight of the tartaric acid is between about 0.1 weight-% and about 50 weight-% relative to a total weight of the citric acid. In some embodiments of a coated citric acid particle a thickness of the tartaric acid is less than a thickness of the citric acid particle. In some embodiments of a coated citric acid particle a moisture content is between about 0.1 weight % and about 10 weight %. In some embodiments of a coated citric acid particle the coated citric acid particle is a core-shell particle.

In another aspect an effervescent powdered beverage composition may include, for example, a coated citric acid particle having citric acid coated with tartaric acid, and a decarboxylated sodium bicarbonate particle wherein the sodium carbonate is generated on a surface of sodium bicarbonate particle. In some embodiments, the effervescent powdered beverage composition includes a particle size of the decarboxylated sodium bicarbonate particle between about 10 μm and about 1000 μm. In some embodiments, the effervescent powdered beverage composition may include a ratio of coated citric acid particles and decarboxylated sodium bicarbonate particles between about 20%:80% and about 80%:20%.

In another aspect, an effervescent powdered beverage composition may include, for example, a coated citric acid particle including citric acid coated with tartaric acid, and a coated sodium bicarbonate particle having sodium bicarbonate coated with sodium carbonate. In some embodiments, the effervescent powdered beverage composition may include a particle size of the coated sodium bicarbonate particle between about 10 μm and about 1000 μm. In some embodiments the effervescent powdered beverage composition includes, for example, a weight of the sodium carbonate between about 0.1 weight % and about 50 weight % relative to a total weight of the sodium bicarbonate. In some embodiments, a thickness of the sodium carbonate is less than a thickness of the sodium bicarbonate. In some embodiments, the effervescent powdered beverage composition further includes one or more ingredients selected from the group consisting of sweeteners, preservatives, fillers, food colorants, vitamins, minerals, botanicals, amino acids, natural flavors, APIs, artificial flavors, antifoaming agents, and combinations thereof. In some embodiments, the effervescent powdered beverage composition further includes one or more ingredients selected from the group consisting of panax ginseng, guarana seed, biotin, pyridoxine, pantothenate, inositol, riboflavin, thiamine, ascorbic acid, niacinamide, cyanocobalamin, caffeine, taurine, stevia, isomaltulose, maltodextrin, citric acid coated with tartaric acid, Effer-Soda (aka decarboxylated sodium bicarbonate), beet root powder, orange flavor, lemon flavor, or combinations thereof. In some embodiments, the effervescent powdered beverage composition may include active pharmaceutical ingredients (API). In some embodiments, the API may be selected from the group consisting of analgesics, antacids, electrolytes, antihistamines, and combinations thereof. In some embodiments, the composition is packaged in a multiple serving container with or without desiccant. In some embodiments, a ratio of coated citric acid particles and coated sodium bicarbonate particles is between about 20%:80% and about 80%:20%. In some embodiments there is more acid than base in the formula to maintain a low pH and rapid effervescent reaction.

In another aspect, a method of producing a coated citric acid particle is disclosed. In some embodiments, the method includes the following steps: (i) exposing a citric acid particle to a fluid bed to form a fluidized citric acid particle; (ii) spraying the fluidized citric acid particle with a coating solution comprising tartaric acid and water to form a coated citric acid particle followed by drying with hot air; and (iii) removing the coated citric acid particle from the fluid bed and cool to ambient temperature. In some embodiments, the steps (i) to (ii) are continued until a desired coating level is achieved. In some embodiments, an inlet air temperature is between about 25° C. and about 95° C.

In some embodiments, a velocity of the processing air flow is at least about 50 cfm. In some embodiments, a velocity of the processing air flow is at least about 900 cfm. In some embodiments, a velocity of the processing air flow is at least about 4000 cfm. In some embodiments, a velocity of the processing air flow is between about 50 cubic feet per minute and about 4000 cubic feet per minute, which is adjusted to stay within 20% to 90% of total air flow for the fluid bed. In some embodiments, step (ii) includes a spray rate of at least about 5 g/min. In some embodiments, step (ii) includes a spray rate of at least about 75 g/min. In some embodiments, step (ii) includes a spray rate of at least about 2000 g/min. In some embodiments, the step (ii) comprises a spray rate of the coating solution between about 5 g/min and about 2000 g/min, which is adjusted during the coating process without causing over-wetting the citric acid particles, defluidization, snow balling, or agglomeration. In some embodiments, the step (ii) includes an atomization air pressure of between about 1 bar and about 15 bar, which is adjusted depending on the size of coating solution spray droplets. In some embodiments, the spray rate and atomization pressure are process control parameters to control the droplet size of the coating solution. In some embodiments, the droplet size is between 20 μm to 150 μm. In some embodiments, the step (ii) comprises an inlet air temperature of between about 25° C. and about 95° C. In some embodiments, the step (ii) comprises top-spraying. In some embodiments, the step (ii) comprises bottom-spraying or tangential-spraying. In some embodiments, the step (ii) comprises an inlet air dew point of between 5° C. and about 20° C. In some embodiments, no binder is used in the coating solution. In some embodiments, the coating solution further comprises a binder. In some embodiments, the binder is selected from the group consisting of maltodextrin, lipid, polymer, and combinations thereof. In some embodiments, the method further includes cooling the coated citric acid particle to an ambient air temperature.

In another aspect, a coated sodium bicarbonate particle is disclosed, which may include, for example, sodium bicarbonate coated with sodium carbonate. In some embodiments, the coated sodium bicarbonate particle. In some embodiments, a particle size of the coated sodium bicarbonate particle is between about 10 μm and about 1000 μm. In some embodiments, a weight of the sodium carbonate is between about 0.1 weight % and about 50 weight % relative to a total weight of the sodium bicarbonate. In some embodiments, a thickness of the sodium carbonate is less than a thickness of the sodium bicarbonate particle. In some embodiments, a moisture content is between about 0.1 weight % and about 10 weight %. In some embodiments, the coated sodium bicarbonate particle is a core-shell particle.

In another aspect, a method of producing a coated sodium bicarbonate particle is disclosed. The method may include, for example, the following steps: (i) exposing a sodium bicarbonate particle to a fluid bed to form a fluidized sodium bicarbonate particle; (ii) spraying the fluidized sodium bicarbonate particle with a coating solution comprising sodium carbonate and water to form a coated sodium bicarbonate particle followed by drying with hot air; and (iii) removing the coated sodium bicarbonate particle from the fluid bed and cool to ambient temperature. In some embodiments, the steps (i) to (ii) are continued until a desired coating level is achieved. In some embodiments, an inlet air temperature is between about 25° C. and about 95° C. In some embodiments, a velocity of the processing air flow is at least about 50 cfm. In some embodiments, a velocity of the processing air flow is at least about 900 cfm. In some embodiments, a velocity of the processing air flow is at least about 4000 cfm. In some embodiments, a velocity of the process air flow is between about 50 cubic feet per minute and about 4000 cubic feet per minute which is adjusted to stay within 20% to 90% of total air flow velocity for the fluid bed. In some embodiments, step (ii) includes a spray rate of at least about 5 g/min. In some embodiments, step (ii) includes a spray rate of at least about 75 g/min. In some embodiments, step (ii) includes a spray rate of at least about 2000 g/min. In some embodiments, the step (ii) comprises a spray rate of the coating solution between about 5 g/min and about 2000 g/min. In some embodiments, the step (ii) includes an atomization air pressure of between about 1 bar and about 15 bar, which is adjusted depending on the size of the coating solution spray droplets. In some embodiments, spray rate and atomization pressure are process control parameters to control the droplet size of the coating solution. In some embodiments, the droplet size is between 20 μm to 150 μm. In some embodiments, the step (ii) comprises an inlet air dew point of between 3° C. and about 20° C. The method, wherein step (ii) comprises top-spraying. In some embodiments, the step (ii) comprises bottom-spraying or tangential-spraying. In some embodiments, the coating solution further comprises a binder. In some embodiments, the binder is selected from the group consisting of maltodextrin, lipid, polymer, and combinations thereof. In some embodiments, a binder is not used. In some embodiments, the method further includes cooling the coated sodium bicarbonate particle to an ambient air temperature.

### BRIEF DESCRIPTION OF THE DRAWINGS

The abovementioned and other features disclosed herein are described below with reference to the drawings of the preferred embodiments. The illustrated embodiments are intended to illustrate, but not to limit the disclosure. The drawings contain the following figures.

FIG. 1 provides a top-spray configuration of a fluidized bed as used in some embodiments of the present disclosure.

FIG. 2 provides a bottom-spray configuration of a fluidized bed as used in some embodiments of the present disclosure.

FIG. 3 provides a tangential-spray configuration of a fluidized bed as used in some embodiments of the present disclosure.

FIG. 4 provides a coating process flow chart for citric acid coated with tartaric acid through low temperature.

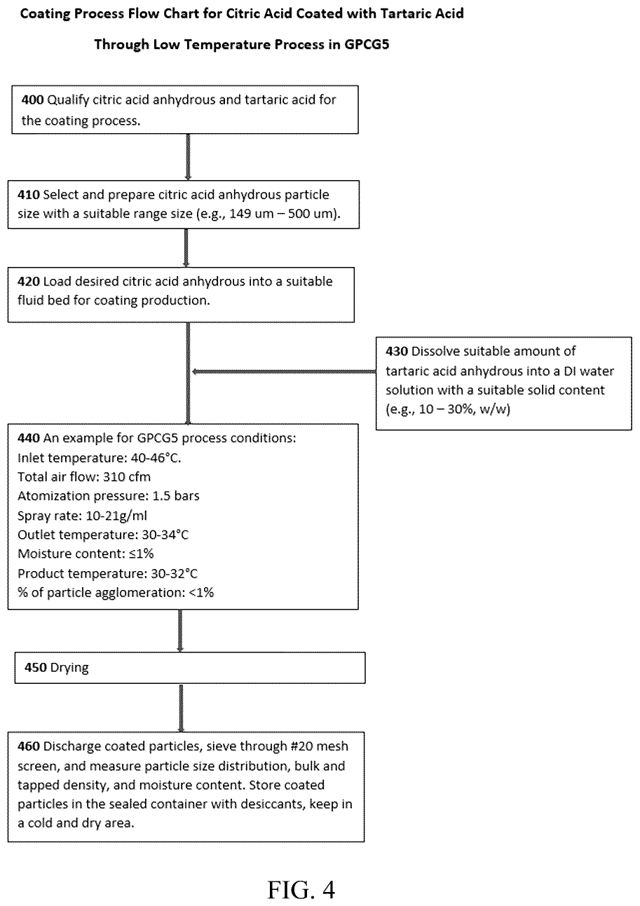

FIG. 5 provides a coating process flow chart for sodium bicarbonate coated with sodium carbonate through low temperature.

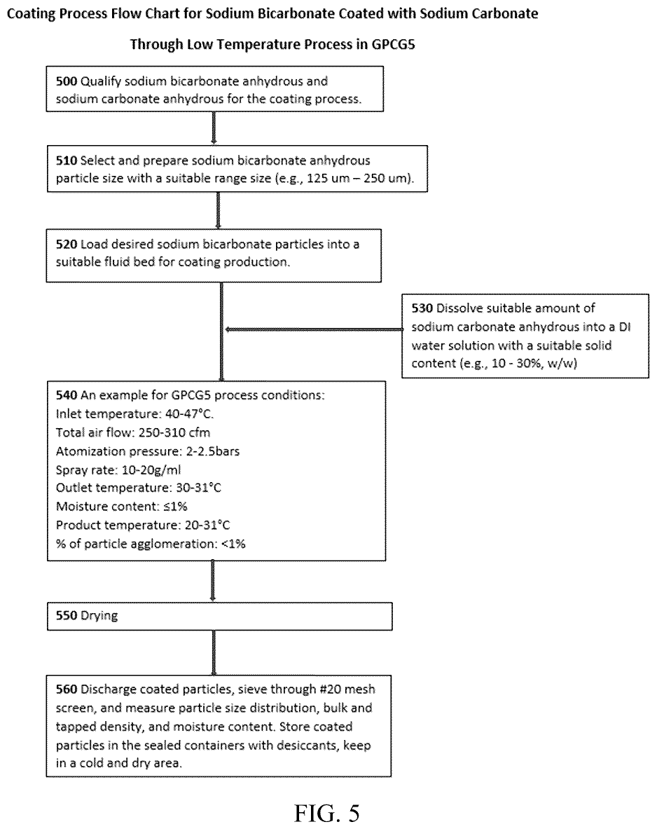

FIG. 6 provides microscopic images of citric acid coated with tartaric acid through low temperature process.

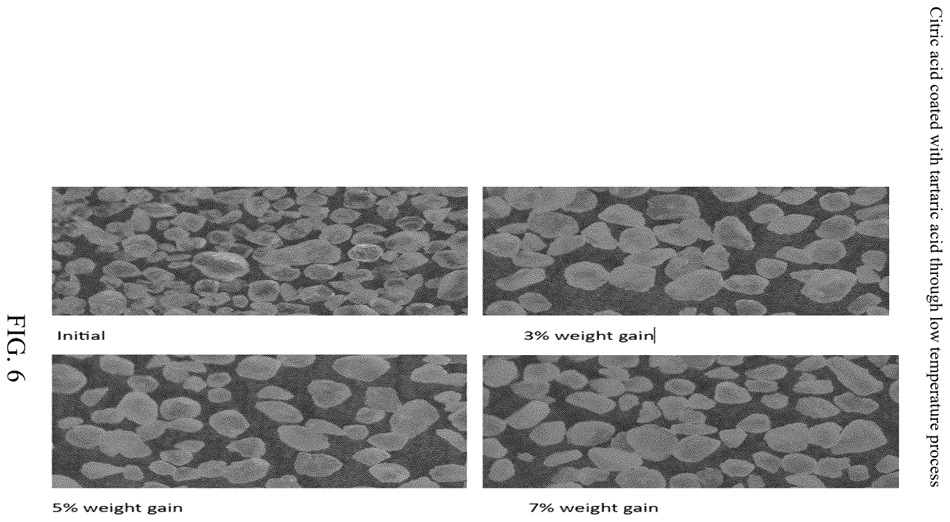

FIG. 7 provides microscopic images of sodium bicarbonate coated with sodium carbonate through low temperature process.

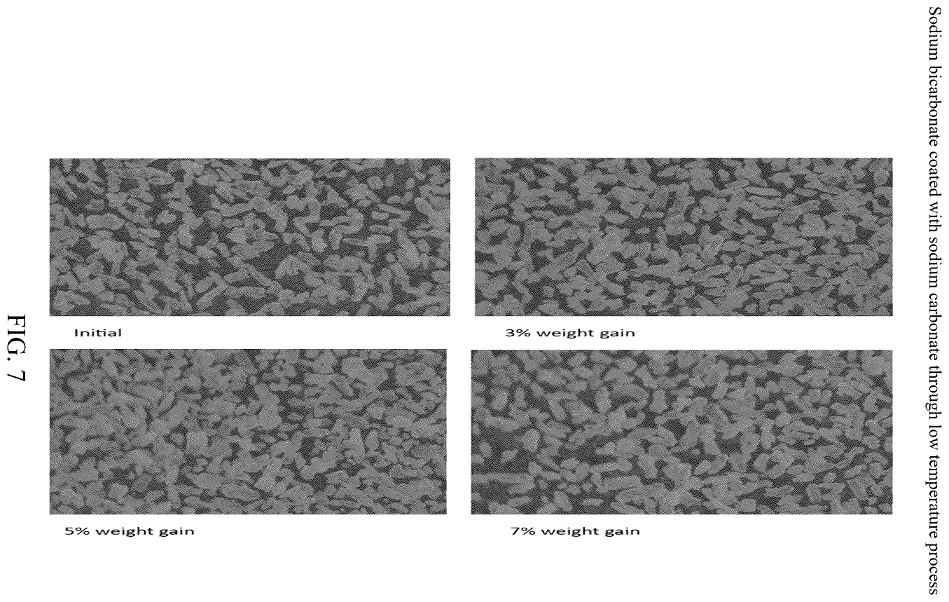

### DETAILED DESCRIPTION

The present disclosure can be understood more readily by referencing the following detailed description, examples, drawings, and claims, and their previous and following descriptions. However, before the present particles, compositions and methods are disclosed and described, it is to be understood that this disclosure is not limited to the specific methods disclosed unless otherwise specified. It is also to be understood that the terminology used herein is for the purpose of describing particular aspects only and is not necessarily intended to be limiting.

The description is provided as an enabling teaching of the disclosure. To this end, those skilled in the relevant art will recognize and appreciate that many changes can be made to the various aspects of the disclosure described herein while still obtaining beneficial results. It will also be apparent that some of the desired benefits can be obtained by selecting some of the features described herein without utilizing other features. Accordingly, those who work in the art will recognize that many modifications and adaptations to the present description are possible and can even be desirable in certain circumstances and are a part of the present disclosure. Thus, this description is provided as illustrative of certain principles of the present disclosure and not in limitation thereof.

### Definitions

Citric acid and tartaric acid. As used herein, “citric acid” and “tartaric acid” refer to the acidic, fully carboxylated form of the polycarboxylic acid. More specifically, the chemical formulae of citric and tartaric acid are C₆H₈O₇ and C₄H₆O₆, respectively.

Tartaric acid, as used herein, refers to its dextrorotatory and levorotatory tartaric acids, and mixtures thereof. In some embodiments, L-tartaric acid is used. In some embodiments, D-tartaric acid is used. In some embodiments, a racemic mixture of tartaric acid is used. For an effervescent reaction, the sodium form of citric acid and tartaric acid are not used.

Decarboxylated sodium bicarbonate particle. As used herein, the term “decarboxylated sodium bicarbonate particle” refers to a particle comprising sodium bicarbonate where between about 5 and about 30% of the sodium bicarbonate has been converted to sodium carbonate by heat in order to improve the moisture sensitivity of the effervescent system. As an example, Effer-Soda™ is a commercial decarboxylated sodium bicarbonate system that provides surface-modified sodium bicarbonate powders for nutraceutical and pharmaceutical applications.

Core-shell particle as used herein refers to a form of a particle comprising two or more ingredients, wherein one ingredient forms a core in the center of the particle, and the other ingredient(s) forms a shell which completely or partially encapsulates the core ingredient.

Effervescent powdered beverage composition, as used herein, refers to a powder form of an effervescent system which, upon placing the powder into water or other suitable liquid media, initiates an effervescent reaction. The effervescent powdered beverage composition contains an acidic component and a basic component. The acidic component may be any food-grade acid such as citric acid, tartaric acid, or any other common food-grade polycarboxylic acids, or combinations thereof. Especially preferred embodiments of the present disclosure use citric acid and tartaric acid. The basic component is typically carbonate salts such as sodium bicarbonate, potassium bicarbonate, or combinations thereof. The reaction between the acid and the base forms carbonic acid, which degrades into CO₂ and water. The CO₂ bubbles through the liquid to provide a refreshing, fizzy taste and sensation, and may also aid in the digestion of other ingredients. Typically, an effervescent system is provided as a stable system where the acid and base components are packaged together in a dry state, and remain inert until the system is placed into an aqueous environment, at which point the acid and base each dissolve and react together to initiate the effervescent reaction. In effervescent powdered beverage compositions, as used herein, both the acidic and basic components may be provided as powders.

### Coated Citric Acid Particle

Some embodiments herein relate to a coated citric acid particle comprising citric acid coated with tartaric acid. Citric acid may be coated by a second ingredient, particularly tartaric acid, for several reasons. One reason may be to prevent premature effervescent reaction when citric acid is exposed to a carbonate base in the presence of environmental moisture. Another reason may be to protect citric acid from excipient ingredients that may impact taste or texture during storage. Other reasons may include to provide for controlled release of citric acid upon an event such as dissolution of citric acid in water or other beverage.

Some embodiments relate to a coated citric acid particle wherein the citric acid particle is coated with tartaric acid. The coated citric acid particle may be of varying size; for example, it may have a diameter of between about 10 μm and about 1000 μm. The size of the coated citric acid particle may vary depending on the specific application. In some embodiments, a plurality of coated citric acid particles may be used, and such plurality may have a monodispersity of sizes, or may have particles of varying sizes, some particles in the plurality being closer to about 10 μm in size and some being closer to about 1000 μm in size. The size of the coated citric acid particle can be measured as a mean particle size in a distribution of particles, such as the geometric mean or arithmetic mean. Analysis of particle size distributions can be performed by any method known in the art, including laser diffraction, dynamic light scattering, dynamic image analysis, or sieve analysis.

In some embodiments of the present disclosure, the coated citric acid particle has a weight of the tartaric acid that is between about 0.1 weight % and about 50 weight % of the total weight of the citric acid component of the particle. The specific proportions of the citric acid and tartaric acid may vary depending on the particular application; for example, higher proportions of citric acid may provide a stronger effervescent reaction or a tarter taste. Lower proportions of citric acid may provide for a slower release of citric acid, thus increasing the duration of the effervescent reaction. Lower proportions of citric acid may also be preferred to modulate the taste profile of the particle or composition comprising the particle, or to vary the moisture sensitivity, or for other reasons related to taste or shelf life or nutritional suitability.

In some embodiments, a plurality of coated citric acid particles may be provided, where the plurality comprises particles with a varying weight % proportion of citric acid to tartaric acid in each particle. Without being bound by theory, it is thought that providing a distribution of weight % proportions may optimize the effervescent strength and taste qualities of the particles with controlled release properties of the particles.

In particular, preferred embodiments include a coated citric acid particle wherein a thickness of the tartaric acid is less than the thickness of the citric acid.

In some embodiments, the tartaric acid coating the citric acid particle may fully coat the surface of the citric acid component, such that the citric acid is fully encapsulated by the tartaric acid. In preferred embodiments, the coated citric acid particle is a core-shell particle featuring a citric acid core and a tartaric acid shell. In other embodiments, the entire surface of the coated citric acid particle is not coated by tartaric acid. In particular, some embodiments feature 90% of the surface of the coated citric acid particle to consist of tartaric acid. Preferred embodiments feature at least 50% of the surface of the coated citric acid particle to be coated with tartaric acid. Where the coating by tartaric acid is less than 100%, that part of the surface area of the citric acid particle not coated with tartaric acid may exist as several isolated patches, or may exist as a single or a few continuous portions. Generally, encapsulation is coating 100% of the surface of the citric acid particle with tartaric acid.

### Coated Sodium Bicarbonate Particle

Some embodiments herein relate to a coated sodium bicarbonate particle comprising sodium bicarbonate coated with sodium carbonate. Sodium bicarbonate may be coated by a second ingredient, particularly sodium carbonate, for several reasons. One reason may be to prevent premature effervescent reaction when sodium bicarbonate is exposed to an acid in the presence of environmental moisture. Another reason may be to protect sodium bicarbonate from excipient ingredients that may impact taste or texture during storage. Other reasons may include to provide for controlled release of sodium bicarbonate upon an event such as dissolution of sodium bicarbonate in water or other beverage.

Some embodiments relate to a coated sodium bicarbonate particle wherein the sodium bicarbonate particle is coated with sodium carbonate. The coated sodium bicarbonate particle may be of varying size; for example, it may have a diameter of between about 10 μm and about 1000 μm. The size of the coated sodium bicarbonate particle may vary depending on the specific application. In some embodiments, a plurality of coated sodium bicarbonate particles may be used, and such plurality may have a monodispersity of sizes, or may have particles of varying sizes, some particles in the plurality being closer to about 10 μm in size and some being closer to about 1000 μm in size. The size of the coated sodium bicarbonate particle can be measured as a mean particle size in a distribution of particles, such as the geometric mean or arithmetic mean. Analysis of particle size distributions can be performed by any method known in the art, including laser diffraction, dynamic light scattering, dynamic image analysis, or sieve analysis.

In some embodiments of the present disclosure, the coated sodium bicarbonate particle has a weight of the sodium carbonate that is between about 0.1 weight % and about 30 weight % of the total weight of the sodium bicarbonate component of the particle. The specific proportions of sodium bicarbonate and sodium carbonate may vary depending on the particular application; for example, higher proportions of sodium bicarbonate may provide a stronger effervescent reaction or a saltier taste. Lower proportions of sodium bicarbonate may provide for a slower release of sodium bicarbonate, thus increasing the duration of the effervescent reaction. Lower proportions of sodium bicarbonate may also be preferred to modulate the taste profile of the particle or composition comprising the particle, or to vary the moisture sensitivity, or for other reasons related to taste or shelf life or nutritional suitability.

In some embodiments, a plurality of coated sodium bicarbonate particles may be provided, where the plurality comprises particles with a varying weight % proportion of sodium bicarbonate to sodium carbonate in each particle. Without being bound by theory, it is thought that providing a distribution of weight % proportions may optimize the effervescent strength and taste qualities of the particles with controlled release properties of the particles.

In particular, preferred embodiments include a coated sodium bicarbonate particle wherein a thickness of the sodium carbonate is less than the thickness of the sodium bicarbonate.

In some embodiments, the sodium carbonate coating the sodium bicarbonate particle may fully coat the surface of the sodium bicarbonate component, such that the sodium bicarbonate is fully encapsulated by the sodium carbonate. In preferred embodiments, the sodium bicarbonate particle is a core-shell particle featuring a sodium bicarbonate core and a sodium carbonate shell. In other embodiments, the entire surface of the coated sodium bicarbonate particle is not coated by sodium carbonate. In particular, some embodiments feature 90% of the surface of the coated sodium bicarbonate particle to consist of sodium carbonate. Preferred embodiments feature at least 50% of the surface of the coated sodium bicarbonate particle to be coated with sodium carbonate. Where the coating by sodium carbonate is less than 100%, that part of the surface area of the sodium bicarbonate particle not coated with sodium carbonate may exist as several isolated patches, or may exist as a single or a few continuous portions. Generally, encapsulation is coating 100% of the surface of the sodium bicarbonate particle with sodium carbonate.

### Effervescent Powdered Beverage Compositions

Some embodiments of the disclosure described herein provide an effervescent powdered beverage composition. Some embodiments of the effervescent powdered beverage composition include, as a first component, a coated citric acid particle comprising citric acid coated with tartaric acid, and may further include, as a second component, a decarboxylated sodium bicarbonate particle, wherein the decarboxylated sodium bicarbonate particle comprises sodium bicarbonate and sodium carbonate, such that the sodium carbonate is present on a surface of the sodium bicarbonate particle.

In some embodiments, the effervescent powdered beverage composition may include a plurality of coated citric acid particles and a plurality of decarboxylated sodium bicarbonate particles. The ratio of coated citric acid particles and decarboxylated sodium bicarbonate particles may be any value; for example, from about 20%:80% coated citric acid particles:decarboxylated sodium bicarbonate particles to about 80%:20% coated citric acid particles:decarboxylated sodium bicarbonate particles. Typically, there is more acid than base in the formula to keep the formula pH below 5.

Other embodiments of the effervescent powdered beverage composition include, as a first component, a coated citric acid particle comprising citric acid coated with tartaric acid, and may further include, as a second component, a coated sodium bicarbonate particle comprising sodium bicarbonate coated with sodium carbonate. In preferred embodiments the sodium carbonate of the coated sodium bicarbonate particle may form a coating around the sodium bicarbonate, such as to fully encapsulate the sodium bicarbonate, or a coating that only partially encapsulates the sodium bicarbonate.

In preferred embodiments, the coated sodium bicarbonate particle has a particle size of between about 10 μM and about 1000 μM as measured by, for example, a mean particle size in a particle size distribution of coated sodium bicarbonate particles. Analysis of particle size distributions can be performed by any method known to the skilled person, including laser diffraction, dynamic light scattering, dynamic image analysis, or sieve analysis.

In some embodiments, the effervescent powdered beverage composition may include a plurality of coated citric acid particles and a plurality of coated sodium bicarbonate particles. The ratio of coated citric acid particles and coated sodium bicarbonate particles may be any value; for example, from about 20%:80% coated citric acid particles:coated sodium bicarbonate particles to about 80%:20% coated citric acid particles:coated sodium bicarbonate particles.

In some embodiments of the effervescent powdered beverage compositions described herein, the compositions further comprise additional ingredients. In some embodiments, these additional ingredients may be selected from the group consisting of sweeteners, preservatives, fillers, food colorants, vitamins, minerals, amino acids, APIs, natural flavors, artificial flavors, botanicals, antifoaming agents, and combinations thereof.

Other embodiments of effervescent powdered beverage compositions may include one or more ingredients selected from the group consisting of microcrystalline cellulose, corn syrup solids, natural fruit flavor, ascorbic acid, sucralose, niacinamide, maltodextrin, riboflavin, biotin, and combinations thereof.

In especially preferred embodiments, the effervescent powdered beverage compositions described herein are provided as, or packaged in, multiple serving containers, with or without desiccant. The containers may be glass jars, HDPE or PCR canisters, foil pouches, etc.

### Pharmaceutical Formulations

In some embodiments, the coated citric acid particle, the coated sodium bicarbonate particle, and/or the effervescent powdered beverage composition can be used, for example, in pharmaceutical formulation. In some embodiments, the pharmaceutical formulation may include a pharmaceutically acceptable carrier or diluent. Pharmaceutically acceptable carriers or diluents for therapeutic use are well known in the pharmaceutical art, and are described, for example in in Remington's Pharmaceutical Sciences, 18th Ed., Mack Publishing Co., Easton, Pa. (1990), which is incorporated herein by reference in its entirety. Preservatives, stabilizers, dyes and even flavoring agents can be provided in the pharmaceutical formulation. Pharmaceutical formulations can be formulated and used as tablets, capsules, powders, granules, or liquids for oral administration.

The pharmaceutical formulation may further include an active pharmaceutical ingredient (API) suitable for the treatment of a disease or disorder. In some embodiments, the API may be selected from the group consisting of analgesics, antacids, electrolytes, antihistamines, and combinations thereof. In some embodiments, the pharmaceutical formulation includes a pharmaceutically effective amount of the API. The effective amount will be determined on an individual basis and will be based on a consideration of the subject (size, age, general health), the condition and the severity of the condition being treated, the severity of the symptoms to be treated, the result sought, the specific carrier or pharmaceutical formulation being used, the route of administration, and other factors as would be apparent to those skilled in the art. The effective amount can be determined by one of ordinary skill in the art using techniques as are known in the art. Therapeutically effective amounts of the pharmaceutical formulations described herein can be determined using in vitro tests, animal models, or other dose-response studies, as are known in the art.

In some embodiments, the pharmaceutical formulation may be suitable for oral administration. In some embodiments, the pharmaceutical formulation may be administered by a single daily dose or multiple daily doses. Pharmaceutical formulations for oral use can be obtained by combining the active ingredients with solid excipient, optionally grinding a resulting mixture, and processing the mixture of granules, after adding suitable auxiliaries, if desired, to obtain tablets or powders. Suitable excipients are, in particular, fillers such as sugars, including lactose, sucrose, mannitol, or sorbitol; cellulose preparations such as, for example, maize starch, wheat starch, rice starch, potato starch, gelatin, gum tragacanth, methyl cellulose, hydroxypropylmethyl-cellulose, sodium carboxymethylcellulose, and/or polyvinylpyrrolidone (PVP).

The pharmaceutical formulations can be manufactured in a manner that is itself known, for example, by means of conventional mixing, dissolving, granulating, dragee making, levitating, emulsifying, encapsulating, entrapping, or lyophilizing processes. In some embodiments, the pharmaceutical formulation further comprises an excipient. In some embodiments, the pharmaceutical formulation is prepared for oral use. In some embodiments, the excipient is sugars, including lactose, sucrose, mannitol, or sorbitol; cellulose preparations such as, for example, maize starch, wheat starch, rice starch, potato starch, gelatin, gum tragacanth, methyl cellulose, hydroxypropylmethyl-cellulose, sodium carboxymethylcellulose, and/or polyvinylpyrrolidone (PVP).

When administered orally, pharmaceutical formulations can be administered in capsule, tablet, granule, spray, syrup, liquid, or other such form. Pharmaceutical formulations can be formed by dissolving a powdered pharmaceutical formulation into a fluid, typically water, fruit or vegetable juice, or milk.

### Methods of Producing a Coated Citric Acid Particle

It is an object of certain embodiments of the present disclosure to provide methods of producing a coated citric acid particle coated with tartaric acid. In particular, the methods described herein may feature steps including (i) exposing a citric acid particle to a fluid bed to form a fluidized citric acid particle, (ii) spraying the fluidized citric acid particle with a coating solution comprising tartaric acid and water to form a coated fluidized citric acid particle followed by drying with hot air, and (iii) removing the coated citric acid particle from the fluid bed.

In some embodiments, steps (i) through (ii) are continued until a desired coating level is achieved. The particles will be coated continuously in the chamber until desired weight gain is achieved.

In some embodiments, the inlet air temperature is between about 25° C. and about 95° C. In some embodiments, the temperature may be selected based on a combination of process variables, such as the spray rate, air flow velocity, atomizing air pressure, quantity of citric acid particles, the size of the fluid bed. In preferred embodiments, the inlet air temperature is below the boiling point of the tartaric acid coating solution to prevent spray-drying the coating solution but high enough to heat the coated citric acid particles and evaporate the moisture.

In some embodiments, a velocity of process air flow to fluidize the particles, in the fluidized bed is between about 50 cubic feet per minute and about 4000 cubic feet per minute, adjusted depending on the size of the fluid bed. In some embodiments, a velocity of the processing air flow is at least about 50 cfm. In some embodiments, a velocity of the processing air flow is at least about 900 cfm. In some embodiments, a velocity of the processing air flow is at least about 4000 cfm, such as 6000 cfm. The velocity of the air flow must be high enough so as to support the particles suspended in the coating zone of the fluid bed chamber.

In some preferred embodiments, the spray rate of the coating solution comprising tartaric acid and water is between about 5 g/min and about 2000 g/min. In some embodiments, the spray rate was controlled between 10 to 25 g/min. In some embodiments, the spray rate was at least 5 g/min. In some embodiments, the spray rate was at least 75 g/min. In some embodiments, the spray rate was at least 2000 g/min. The spray rate may be selected according to a combination of process variables, including the targeted particle size distribution of coated particles, viscosity of coating solution, atomization air pressure, temperature and/or humidity of particles, quantity of citric acid particles, and size of the fluid bed. The optimal spray rate may depend on one or more other properties of the citric acid or tartaric acid, including the evaporation capacity of water from coating solution, the tackiness of the specific coating solution used, the velocity of the citric acid particles traveling through the coating zone, coating target weight gain and any other properties or variables. In some embodiments, the spray rate is varied to maintain a constant temperature measured as the outlet air temperature and product bed temperature.

In some embodiments, the atomization air pressure of the coating solution spray is between about 1 bar and about 15 bar. The atomization air pressure may be varied to determine the coating solution droplet size, where higher pressures correspond to finer droplet sizes. The droplet size may be increased or decreased according to the particular application; for example, to optimize the coating solution droplet size and coalescence of tartaric acid on the surface of citric acid particle being coated. In some embodiments, the coating solution is controlled by its spray rate and atomization air pressure. In some embodiments, the spray rate is 10-25 g/mL and the atomization air pressure is 1-3 bars.

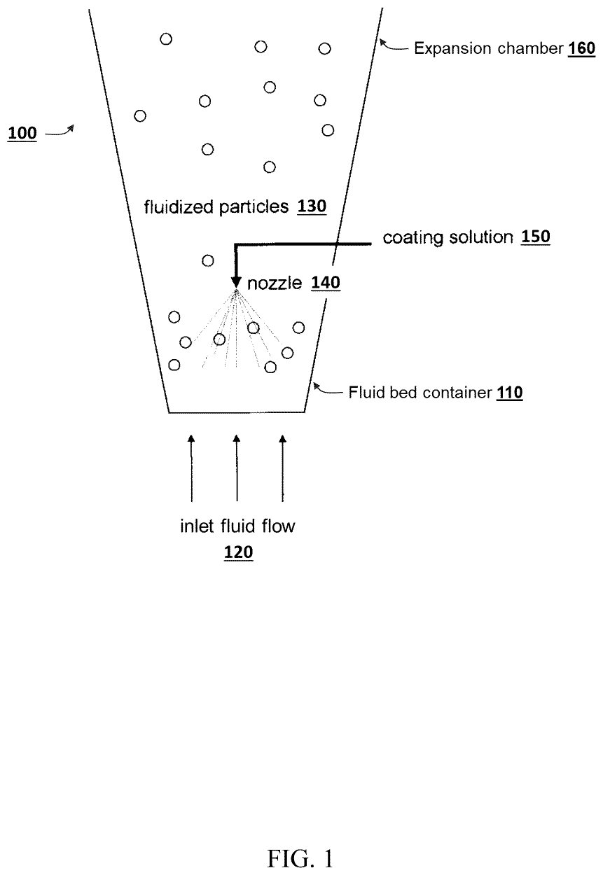

In some embodiments, the coated citric acid particle is produced using a top-spray configuration. FIG. 1 illustrates a top-spray fluid bed configuration 100 in accordance with some embodiments. The fluid bed configuration 100 includes a fluid bed container 110 surrounding the fluid bed configuration 100. An inlet air flow 120 fluidizes the fluidized particles 130. A nozzle 140 sprays a coating solution 150 onto the fluidized particles 130 such as to coat the fluidized particles. The coated fluidized particles travel through the fluid bed container and into an expansion chamber 160, where they can be dried.

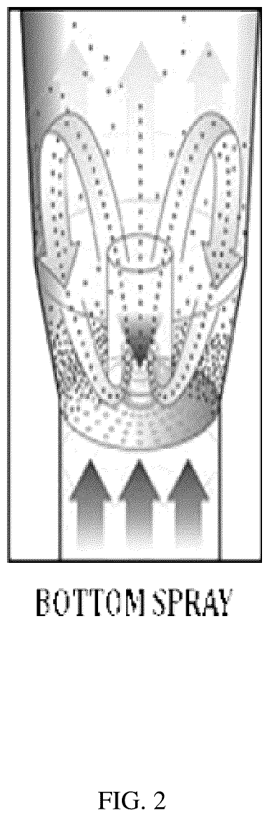

In other embodiments, the coated citric acid particle is produced using a bottom-spray configuration (also known as a Wurster system). FIG. 2 illustrates a bottom-spray fluid bed configuration in accordance with some embodiments. As in the top-spray configuration, a fluid bed container surrounds the bottom-spray configuration. An inlet air flow is provided to fluidize the particles, such that the path of the coating solution, sprayed from the nozzle, is very short to reduce premature droplet evaporation. The bottom-spray method may be especially advantageous when small coated particle sizes, such as 100 μm or smaller, are desired.

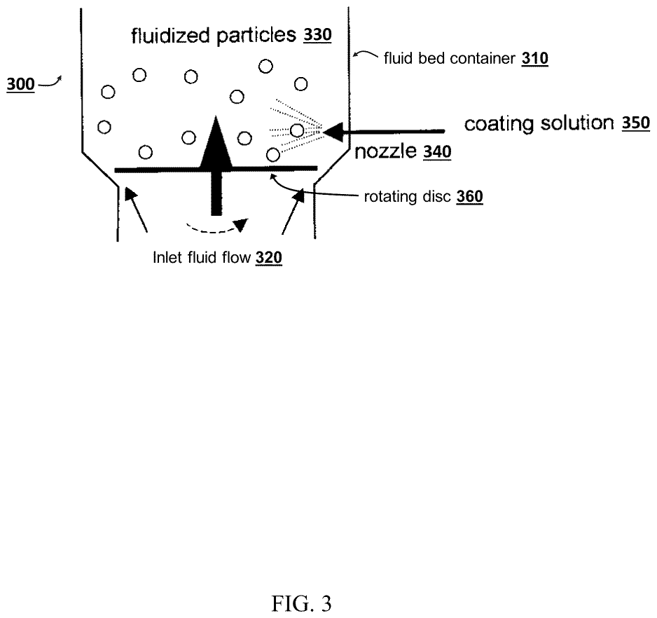

In other embodiments, a tangential-spray fluidized bed configuration may be used. FIG. 3 illustrates a tangential-spray fluid bed configuration 300 in accordance with some embodiments. A fluid bed container 310 surrounds the tangential-spray configuration 300. An inlet air flow 320 fluidizes the fluidized particles 330. A rotating disc 360 causes the fluidized particles to rotate inside the fluid bed container 310, where a nozzle 340 sprays the coating solution 350 tangentially onto the fluidized particles 330. Tangential-spray fluidized beds typically utilize three forces to increase the efficiency of particle coating: centrifugal force by a rotating disc that causes the citric acid particles to move toward the wall of the chamber, air velocity from the bottom that provides acceleration to the particles upward, and gravity moving the product inward and toward the disc again.

### Methods of Producing a Coated Sodium Bicarbonate Particle

It is an object of certain embodiments of the present disclosure to provide methods of producing a coated sodium bicarbonate particle coated with sodium carbonate. In particular, the methods described herein may feature steps including (i) exposing a sodium bicarbonate particle to a fluid bed to form a fluidized sodium bicarbonate particle, (ii) spraying the fluidized sodium bicarbonate particle with a coating solution comprising sodium carbonate and water to form a coated fluidized sodium bicarbonate particle followed by drying with hot air, and (iii) removing the coated sodium bicarbonate particle from the fluid bed.

In some embodiments, steps (i) through (ii) are continued until a desired coating level is achieved. The particles will be coated continuously in the chamber until desired weight gain is achieved.

In some embodiments, the inlet air temperature is between about 25° C. and about 95° C. In some embodiments, the temperature may be selected based on a combination of process variables, such as the spray rate, air flow velocity, atomizing air pressure, quantity of sodium bicarbonate particles, and the size of the fluid bed. In preferred embodiments, the inlet air temperature is below the boiling point of the sodium carbonate coating solution to prevent spray-drying the coating solution but high enough to heat the coated sodium bicarbonate particles and evaporate the moisture.

In some embodiments, a velocity of process air flow to fluidize the particles, in the fluidized bed is between about 50 cubic feet per minute and about 4000 cubic feet per minute. In some embodiments, a velocity of the processing air flow is at least about 50 cfm. In some embodiments, a velocity of the processing air flow is at least about 900 cfm. In some embodiments, a velocity of the processing air flow is at least about 4000 cfm, such as 6000 cfm. The velocity of the air flow must be high enough so as to support the particles suspended in the coating zone of the fluid bed chamber.

In some preferred embodiments, the spray rate of the coating solution comprising tartaric acid and water is between about 5 g/min and about 2000 g/min. In some embodiments, the spray rate was at least 5 g/min. In some embodiments, the spray rate was at least 75 g/min. In some embodiments, the spray rate was at least 2000 g/min. The spray rate may be selected according to a combination of process variables, including the targeted particle size distribution of coated particles, viscosity of coating solution, atomization air pressure, temperature and/or humidity of particles, quantity of sodium bicarbonate particles, and size of the fluid bed. The optimal spray rate may depend on one or more other properties of the sodium bicarbonate or sodium carbonate, including the evaporation capacity of water from coating solution, the tackiness of the specific coating solution used, the velocity of the sodium bicarbonate particles traveling through the coating zone, coating target weight gain and any other properties or variables. In some embodiments, the spray rate is varied to maintain a constant temperature measured as the outlet air temperature and product bed temperature.

In some embodiments, the atomization air pressure of the coating solution spray is between about 1 bar and about 15 bar. The atomization air pressure may be varied to determine the coating solution droplet size, where higher pressures correspond to finer droplet sizes. The droplet size may be increased or decreased according to the particular application; for example, to optimize the coating solution droplet size and coalescence of sodium carbonate on the surface of sodium bicarbonate particle being coated.

In some embodiments, the coated sodium bicarbonate particle is produced using a top-spray configuration. FIG. 1 illustrates a top-spray fluid bed configuration 100 in accordance with some embodiments. The fluid bed configuration 100 includes a fluid bed container 110 surrounding the fluid bed configuration 100. An inlet air flow 120 fluidizes the core particles 130. A nozzle 140 sprays a coating solution 150 onto the fluidized particles 130 such as to coat the fluidized particles. The coated fluidized particles travel through the fluid bed container and into an expansion chamber 160, where they can be dried.

In other embodiments, the coated sodium bicarbonate particle is produced using a bottom-spray configuration (also known as a Wurster system). FIG. 2 illustrates a bottom-spray fluid bed configuration in accordance with some embodiments. As in the top-spray configuration, a fluid bed container surrounds the bottom-spray configuration. An inlet air flow is provided to fluidize the particles, such that the path of the coating solution, sprayed from the nozzle, is very short to reduce premature droplet evaporation. The bottom-spray method may be especially advantageous when small coated particle sizes, such as 100 μm or smaller, are desired.

In other embodiments, a tangential-spray fluidized bed configuration may be used. FIG. 3 illustrates a tangential-spray fluid bed configuration 300 in accordance with some embodiments. A fluid bed container 310 surrounds the tangential-spray configuration 300. An inlet air flow 320 fluidizes the core particles 330. A rotating disc 360 causes the fluidized particles to rotate inside the fluid bed container 310, where a nozzle 340 sprays the coating solution 350 tangentially onto the fluidized particles 330. Tangential-spray fluidized beds typically utilize three forces to increase the efficiency of particle coating: centrifugal force by a rotating disc that causes the sodium bicarbonate particles to move toward the wall of the chamber, air velocity from the fluid flow that provides acceleration to the particles upward, and gravity moving the product inward and toward the disc again.

### EXAMPLES

Embodiments of the present disclosure are further defined in the following Examples. It should be understood that these Examples are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims. The disclosure of each reference set forth herein is incorporated herein by reference in its entirety.

### Example 1: Preparation of a Coated Citric Acid Particle Coated with Tartaric Acid by Using a Fluid Bed

A solution of tartaric acid (ca. 0.65 kg) and demineralized water (ca. 3.68 kg) is prepared in a double-wall vessel with stirrer (about 4.3 L).

The tartaric acid solution is pumped using a tube pump into the fluid bed spray nozzle of a GPCG-5 pilot GLATT™, which is a commercially available fluid bed system.

The basket of the pilot GLATT™ fluid bed is filled with 9.4 kg of citric acid. The starting material is heated up to 30° C. to 40° C. during fluidization of the product. The inlet airflow speed is set to 100 to 250 cubic feet per minute. Spraying tartaric acid solution is started upon product temperature reaching 30° C. After a few minutes, the airflow is set at 200 cubic feet per minute. The inlet air temperature is set to 40° C. to 50° C. An average spray rate of 15 g/min is used and the automizing air pressure is set to 1.5 bar. Spraying tartaric acid is stopped after 150 minutes. The coated citric acid product is dried at 30° C. for about 45 minutes. The product is then removed from the fluid bed and cooled to ambient temperature, then collected in double-layer plastic bags with added desiccants.

Microscopic pictures demonstrate that the resulting product is a mixture of citric acid particles coated with tartaric acid with particle size between 100 μm and 1000 μm.

### Example 2: Preparation of a Sodium Bicarbonate Particle Coated with Sodium Carbonate

A solution of sodium carbonate (ca. 0.65 kg) and demineralized water (ca. 3.68 kg) is prepared in a double-wall vessel with stirrer (about 4.3 L).

The sodium carbonate solution is pumped using a tube pump into the fluid bed spray nozzle of a GPCG-5 pilot GLATT™, which is a commercially available fluid bed system.

The basket of the pilot GLATT™ fluid bed dryer is filled with 9.4 kg of sodium bicarbonate. The starting material is heated up to 30° C. to 40° C. during fluidization of the product. The inlet airflow speed is set to 100 to 200 cubic feet per minute. Spraying sodium carbonate solution is started upon product temperature reaching 30° C. After a few minutes, the airflow is set at 150 cubic feet per minute. The inlet air temperature is set to 40° C. to 50° C. An average spray rate of 15 g/min is used and the automizing air pressure is set to 2.0 to 2.5 bar. Spraying sodium carbonate is stopped after about 200 minutes. The coated sodium bicarbonate product is dried at 30° C. for about 45 minutes. The product is then removed from the fluid bed and cooled to ambient temperature, then collected in double-layer plastic bags with added desiccants.

Microscopic pictures demonstrate that the resulting product is a mixture of sodium bicarbonate particles coated with sodium carbonate with particle size between 100 μm and 1000 μm.

### Example 3: Preparation of an Effervescent Powdered Beverage Composition

An effervescent powdered beverage is formulated having the ingredients and relative amounts listed in Table 1.

TABLE 1

| Ingredients | % In Formula |
|---|---|
| COATED CITRIC ACID W/ TARTARIC ACID | 44.0 |
| PANAX GINSENG, | 2.7 |
| GUARANA SEED EXTRACT | 0.9 |
| BIOTIN | 0.9 |
| PYRIDOXINE HYDROCHLORIDE | 0.3 |
| D-CALCIUM PANTOTHENATE | 0.7 |
| INOSITOL | 0.7 |
| RIBOFLAVIN | 0.1 |
| THIAMINE MONONITRATE | 0.1 |
| ASCORBIC ACID | 1.7 |
| NIACINAMIDE | 0.6 |
| CYANOCOBALAMIN | 0.4 |
| CAFFEINE | 1.8 |
| L-TAURINE | 2.9 |
| SUCRALOSE | 0.2 |
| REBAUDIOSIDE A | 1.1 |
| ISOMALTULOSE | 0.9 |
| RESISTANT MALTODEXTRIN | 13.9 |
| DECARBOXYLATED SODIUM BICARBONATE | 19.1 |
| COLOR, FD&C YELLOW #6 | 0.01 |
| FLAVOR, NATURAL ORANGE | 7.0 |
| Total | 100.0% |

### Example 4: Preparation of an Effervescent Powdered Beverage Composition

An effervescent powdered beverage is formulated having the ingredients and relative amounts listed in Table 2.

TABLE 2

| Ingredients | % In Formula |
|---|---|
| COATED CITRIC ACID W/ TARTARIC ACID | 44.0 |
| PANAX GINSENG, | 2.7 |
| GUARANA SEED EXTRACT | 0.9 |
| BIOTIN | 0.9 |
| PYRIDOXINE HYDROCHLORIDE | 0.3 |
| D-CALCIUM PANTOTHENATE | 0.7 |
| INOSITOL | 0.7 |
| RIBOFLAVIN | 0.1 |
| THIAMINE MONONITRATE | 0.1 |
| ASCORBIC ACID | 1.7 |
| NIACINAMIDE | 0.6 |
| CYANOCOBALAMIN | 0.4 |
| CAFFEINE | 1.8 |
| L-TAURINE | 2.9 |
| SUCRALOSE | 0.2 |
| REBAUDIOSIDE A | 1.1 |
| ISOMALTULOSE | 0.9 |
| RESISTANT MALTODEXTRIN | 13.9 |
| COATED SODIUM BICARBONATE W/ SODIUM | 19.1 |
| CARBONATE | |
| COLOR, FD&C YELLOW #6 | 0.01 |
| FLAVOR, NATURAL ORANGE | 7.0 |
| Total | 100% |

### Example 5: Stability Data of Effervescent Powdered Beverage Composition

In an accelerated stability testing study, an effervescent powdered beverage composition comprising coated citric acid particles, coated sodium bicarbonate particles, vitamins, caffeine, botanicals, inositol, taurine, sweeteners, bulking agents, natural cola flavor, and natural color is subjected to elevated stress conditions to predict its shelf life.

The effervescent powdered beverage composition is packaged in a sealed 8-ounce high-density polyethylene (HDPE) jar with 3-grams of desiccant. Each jar contains 30 servings of the effervescent powder beverage composition.

The packaged effervescent powdered beverage composition is stored at 40° C. and 75% relative humidity for a duration of 4.5 months. Samples are analyzed at predetermined intervals for physical and chemical stability, including characteristics such as appearance, color, odor, taste, potency of active ingredients, and impurity levels.

The stability testing results as shown in Table 3 indicate that the effervescent powdered beverage composition maintains its physical and chemical performance over the 4.5-month period under the study conditions, with all parameters tested meeting the preset performance specifications. Based on the stability testing results, a shelf life of at least approximately 18 to 24 months under normal storage conditions is predicted.

TABLE 3

| | Stability | Unit Of | | | | | |
|---|---|---|---|---|---|---|---|
| Appearance | Specification | Measure | 0 Months | 1 Months | 2 Months | 3 Months | 4.5 Months |
| Appearance | FREE | N/A | Pass. | Pass. | Pass. | Pass. | Pass. |
| | FLOWING | | Powder | Powder | Powder | Powder | Powder- |
| | POWDER | | | | | | Slight |
| | | | | | | | agglomeration |
| Color | OFF WHITE | N/A | Pass. | Pass. | Pass. | Pass. | Pass. |
| | TO LIGHT | | Light grey | Light grey | Light grey | Light grey | Light grey |
| | GREY | | with dark | with dark | with dark | with dark | with dark |
| | | | specks | specks- | specks- | specks- | specks- |
| | | | | Slightly | Slightly | Slightly | Slightly |
| | | | | more orange | more orange | more orange | more orange |
| | | | | than | than | than | than |
| | | | | control | control | control | control |
| Odor | COLA | N/A | Pass Cola | Pass. | Pass. | Pass. | Pass. |
| | | | | Very mild | Very mild | Very mild | Very mild |
| | | | | cola- | cola- | cola- | cola |
| | | | | Slightly | Slightly | Slightly | |
| | | | | weaker than | weaker than | weaker than | |
| | | | | control | control | control | |
| Appearance | AS PREPARED: | N/A | Pass. | Pass. | Pass. | Pass. | Pass. |
| (As | POUR 240 mL | | Translucent | Translucent | Translucent | Translucent | Translucent |
| Prepared) | OF COLD | | liquid | liquid | liquid | liquid- | liquid- |
| | WATER INTO | | | | | Slightly | Slightly |
| | A 5G SAMPLE | | | | | less foam | less foam |
| | IN A CUP | | | | | and more | and more |
| | MIX GENTLY | | | | | sediment | sediment |
| | HAZY TO | | | | | than | than |
| | OPAQUE | | | | | control | control |
| | LIQUID | | | | | | |
| | WITH FOAM | | | | | | |
| Odor (As | AS PREPARED: | N/A | Pass. | Pass. | Pass. | Pass. | Pass. |
| Prepared) | POUR 240 mL | | Cola | Cola | Cola | Cola | Cola |
| | OF COLD | | | | | | |
| | WATER INTO | | | | | | |
| | A 5G SAMPLE | | | | | | |
| | IN A CUP | | | | | | |
| | MIX GENTLY | | | | | | |
| | COLA | | | | | | |
| Taste (As | AS PREPARED: | N/A | Pass, | Pass, | Pass, | Pass, | Pass, |
| Prepared) | POUR 240 mL | | Sweet, | Sweet, | Sweet, | Sweet, | Sweet, |
| | OF COLD | | Tart, Cola | Tart, Cola | Tart, | Tart, | Tart, |
| | WATER INTO | | | | Cola- | Cola- | Cola- |
| | A 5G SAMPLE | | | | Slightly | Slightly | Slightly |
| | IN A CUP | | | | more tart | more tart | more tart, |
| | MIX GENTLY | | | | and more | and more | less sweet, |
| | SWEET, TART, | | | | spice | spice | and more |
| | COLA | | | | flavor | flavor | spice |
| | | | | | than | than | flavor |
| | | | | | control | control | than |
| | | | | | | | control |
| Color (As | AS PREPARED: | N/A | Pass. | Pass. | Pass. | Pass. | Pass. |
| Prepared) | POUR 240 mL | | Brown | Brown | Brown- | Brown- | Brown- |
| | OF COLD | | | | Slightly | Slightly | Slightly |
| | WATER INTO | | | | lighter | lighter | darker |
| | A 5G SAMPLE | | | | than | than | than |
| | IN A CUP | | | | control | control | control |
| | MIX GENTLY | | | | | | |
| | BROWN | | | | | | |
| Packaging | INTACT | N/A | Pass. | Pass. | Pass. | Pass. | Pass. |
| | SEAL AND | | Intact seal | Intact seal | Intact seal | Intact seal | Intact seal |
| | PACKAGE | | and | and | and | and | and |
| | | | package | package | package | package | package |
| Total Plate | <10,000 | cfu/g | <1000 | <1000 | <1000 | <1000 | <1000 |
| Count | | | | | | | |
| Yeast & Mold | <300 | cfu/g | 34 | <10 | 100 | <100 | <100 |
| E. Coli | None | 10 g | None | None | None | None | None |
| | detected | | detected | detected | detected | detected | detected |
| Staphylococcus | None | 10 g | None | None | None | None | None |
| Aureus | detected | | detected | detected | detected | detected | detected |
| Salmonella | None | 25 g | None | None | None | None | None |
| | detected | | detected | detected | detected | detected | detected |
| Loss on | NMT 2.0 | % | 2.0 | 1.5 | 1.5 | 1.1 | 1.6 |
| Drying | | | | | | | |
| (LOD) | | | | | | | |
| pH | 3.0-4.1 | N/A | 4.3 | 4.3 | 4.2 | 4.2 | 4.0 |
| Calories | 11-17 | Kcal | 14 | — | — | — | — |
| Total | 4.0-6.0 | g | 3.1 | — | — | — | — |
| Carbohydrates | | | | | | | |
| Dietary Fiber | Report | g | 1 | — | — | — | — |
| | Results | | | | | | |
| Sugar Alcohol | <0.5 | g | 0.0 | — | — | — | — |
| Total Fat | <0.5 | g | 0.0 | — | — | — | — |
| Sodium | 290-435 | mg | 306 | — | — | — | — |
| Potassium | <10 | mg | 10 | — | — | — | — |
| Vitamin B1 | 3.0-5.0 | mg | 4.0 | 4.6 | 4.2 | 4.0 | 4.1 |
| (Thiamine | | | | | | | |
| Mononitrate) | | | | | | | |
| Vitamin B2 | 1.7-3.0 | mg | 3.1 | 2.8 | 3.0 | 3.2 | 3.3 |
| (Riboflavin) | | | | | | | |
| Vitamin B3 | 20-35 | mg | 27 | 28 | 29 | 26 | 26 |
| (Niacinamide/ | | | | | | | |
| Nicotinamide) | | | | | | | |
| Vitamin B5 | 20-33 | mg | 25 | 24 | 25 | 25 | 25 |
| (Pantothenic | | | | | | | |
| Acid) | | | | | | | |
| Vitamin B6 | 6-13 | mg | 9 | 10 | 9 | 9 | 9 |
| (Pyridoxine | | | | | | | |
| Hydrochloride) | | | | | | | |
| Biotin | 300-570 | mcg | 399 | 418 | 403 | 395 | 410 |
| Vitamin B12 | 12.0-24.0 | mcg | 20.6 | 19.5 | 17.5 | 17.3 | — |
| (0.1% | | | | | | | |
| Cyanocobalamin | | | | | | | |
| on Maltodextrin) | | | | | | | |
| Vitamin C | 60.0-90.0 | mg | 70.1 | 75.0 | 71.1 | 75.9 | 71.1 |
| (Ascorbic Acid) | | | | | | | |
| Arsenic | Report | ppb | 25 | — | — | — | — |
| | Results | | | | | | |
| Cadmium | Report | ppb | 2 | — | — | — | — |
| | Results | | | | | | |
| Lead | Report | ppb | 10 | — | — | — | — |
| | Results | | | | | | |
| Mercury | Report | ppb | 2 | — | — | — | — |
| | Results | | | | | | |
| Inositol | 26-52 | mg | 37 | 35 | 30 | 33 | 33 |
| L-Taurine | 102-150 | mg | 121 | 122 | 143 | 131 | — |
| Caffeine | 75-100 | mg | 79 | 75 | 76 | 80 | — |

The disclosure is generally described herein using affirmative language to describe the numerous embodiments. The disclosure also includes embodiments in which subject matter is excluded, in full or in part, such as substances or materials, method steps and conditions, protocols, or procedures.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “about” or “approximately” means within an acceptable error range for the particular value as determined by one of ordinary skill in the art, which will depend in part on how the value is measured or determined, e.g., the limitations of the measurement system. For example, “about” can mean within 1 or more than 1 standard deviations, per the practice in the art. Alternatively, “about” can mean a range of up to 20%, up to 10%, up to 5%, and up to 1% of a given value. Alternatively, particularly with respect to biological systems or processes, the term can mean within an order of magnitude, within 5-fold, and within 2-fold, of a value. Where particular values are described in the application and claims, unless otherwise stated the term “about” meaning within an acceptable error range for the particular value should be assumed.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An effervescent powdered beverage composition, comprising:
a coated citric acid particle comprising citric acid coated with tartaric acid; and
a decarboxylated sodium bicarbonate particle comprising sodium bicarbonate and sodium carbonate,
wherein the sodium carbonate is present on a surface of the decarboxylated sodium bicarbonate particle.

2. The effervescent powdered beverage composition of claim 1, wherein a ratio of coated citric acid particles and decarboxylated sodium bicarbonate particles is between about 20%:80% and about 80%:20%.

3. An effervescent powdered beverage composition, comprising:
a coated citric acid particle comprising citric acid coated with tartaric acid; and
a coated sodium bicarbonate particle comprising sodium bicarbonate coated with sodium carbonate.

4. The effervescent powdered beverage composition of claim 3, wherein a particle size of the coated sodium bicarbonate particle is between about 10 μm and about 1000 μm.

5. The effervescent powdered beverage composition of claim 3, wherein a weight of the sodium carbonate is between about 5 weight-% and about 50 weight-% relative to a total weight of the sodium bicarbonate.

6. The effervescent powdered beverage composition of claim 3, wherein a thickness of the sodium carbonate is less than a thickness of the sodium bicarbonate.

7. The effervescent powdered beverage composition of claim 3, further comprising one or more ingredients selected from the group consisting of sweeteners, preservatives, fillers, food colorants, vitamins, minerals, amino acids, botanicals, active pharmaceutical ingredients, natural flavors, artificial flavors, antifoaming agents, and combinations thereof.

8. The effervescent powdered beverage composition of claim 7, further comprising one or more ingredients selected from the group consisting of microcrystalline cellulose, corn syrup solids, natural fruit flavor, ascorbic acid, sucralose, niacinamide, maltodextrin, riboflavin, biotin, and combinations thereof.

9. The effervescent powdered beverage composition of claim 1, wherein the composition is packaged in a multiple serving container including a desiccant.

10. The effervescent powdered beverage composition of claim 9, wherein the packaging container includes aluminum foil pouch, HDPE or PCR canister, or glass jar.

11. The effervescent powdered beverage composition of claim 1, wherein a ratio of coated citric acid particles and coated sodium bicarbonate particles or decarboxylated sodium bicarbonate is between about 20%:80% and about 80%:20%.
